(19) United States
(12) Patent Application Publication
(10) Pub. No.: US 2008/0185988 A1
(43) Pub. Date: Aug. 7, 2008

(54) Solar garden light device

(76) Inventor: Chen-Yueh Fan, Taipei (TW)

Correspondence Address: COOPER & DUNHAM, LLP, 1185 AVENUE OF THE AMERICAS, NEW YORK, NY, 10036, US

(21) Appl. No.: 11/703,583

(22) Filed: Feb. 7, 2007

(51) Int. Cl. H02J 7/35

(52) U.S. Cl. 320/101

(57) ABSTRACT

A solar garden light device has at least one lamp, a rechargeable device and a solar array. Each one of the at least one lamp has a casing, a through hole and a light assembly. The casing has a top end. The through hole is defined in the casing adjacent to the top end. The light assembly is mounted in the casing and lights. The rechargeable device has a control circuit and a rechargeable battery. The rechargeable battery is connected electrically to the control circuit and the light assembly. The solar array is connected electrically to the control circuit, converts sunlight to direct current (DC) electricity and recharges the rechargeable battery. Therefore, the solar array can absorb solar energy and transfer solar energy to electric energy to store electricity in the rechargeable battery. Then the rechargeable battery supplies power to the light.

### BACKGROUND OF THE INVENTION

1. Field of the Invention

The present invention relates to a light device, and especially a solar garden light device that is powered by solar energy.

2. Description of the Related Art

With modern developments in technology, people's lives are more and more convenient. Therefore, demand for electricity is very critical. However, global resources such as petroleum and natural gas necessary to generate electricity are being depleted so that the cost of global resources is continually increasing. Therefore, many researchers are studying how to convert solar energy to electricity by new devices such as high efficiency solar arrays.

A conventional garden light device is powered by an external electric power source. Therefore, converting solar energy to electricity to light will decrease the consumption of petroleum and natural gas and protect the environment against destruction.

### SUMMARY OF THE INVENTION

The objective of the present invention is to provide a solar garden light device, which absorbs sunlight and converts solar energy to electricity causing the light device to emit light.

To achieve the foregoing objective, a solar garden light device in accordance with the present invention has at least one lamp, a rechargeable device and a solar array. Each one of the at least one lamp has a casing, a through hole and a light assembly. The casing has a top end. The through hole is defined in the casing adjacent to the top end. The light assembly is mounted in the casing and lights. The rechargeable device has a control circuit and a rechargeable battery. The rechargeable battery is connected electrically to the control circuit and the light assembly. The solar array is connected electrically to the control circuit, converts sunlight to direct current (DC) electricity and recharges the rechargeable battery. Therefore, the solar array can absorb solar energy and transfer solar energy to electric energy to store electricity in the rechargeable battery. Then the rechargeable battery supplies power to the light.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a solar garden light device in accordance with the present invention;

FIG. 2 is a control circuit diagram of the solar garden light device in FIG. 1; and

FIG. 3 is a perspective view of a second embodiment of the solar garden light device in accordance with the present invention.

### DETAILED DESCRIPTION OF THE PREFERRED EMBODIMENTS

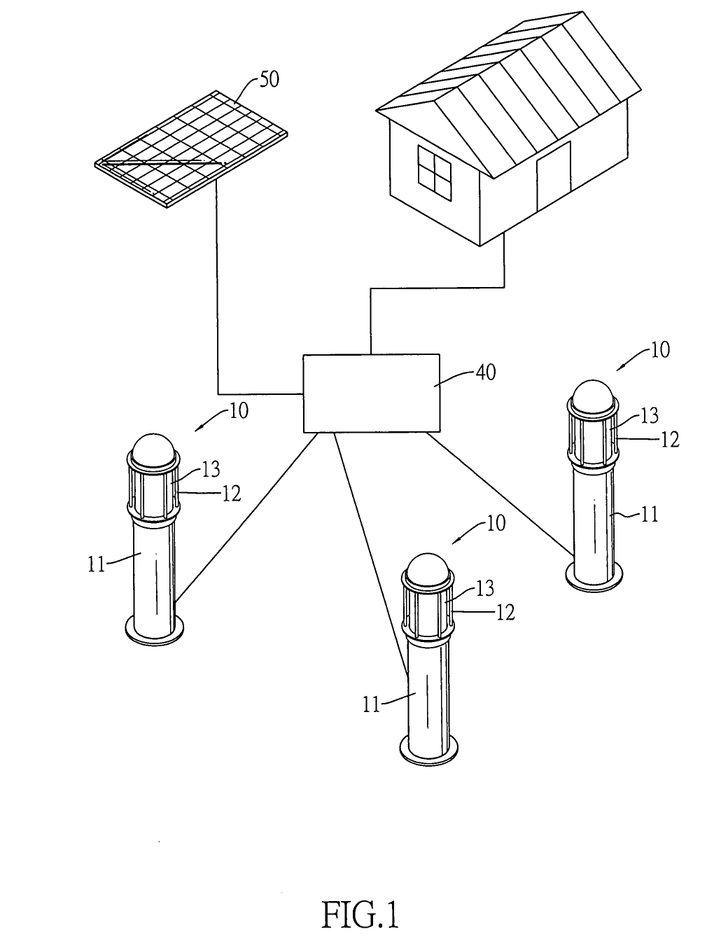

With reference to FIGS. 1 to 3, a solar garden light device in accordance with the present invention comprises at least one lamp (10, 10a), a rechargeable device (40) and a solar array (50).

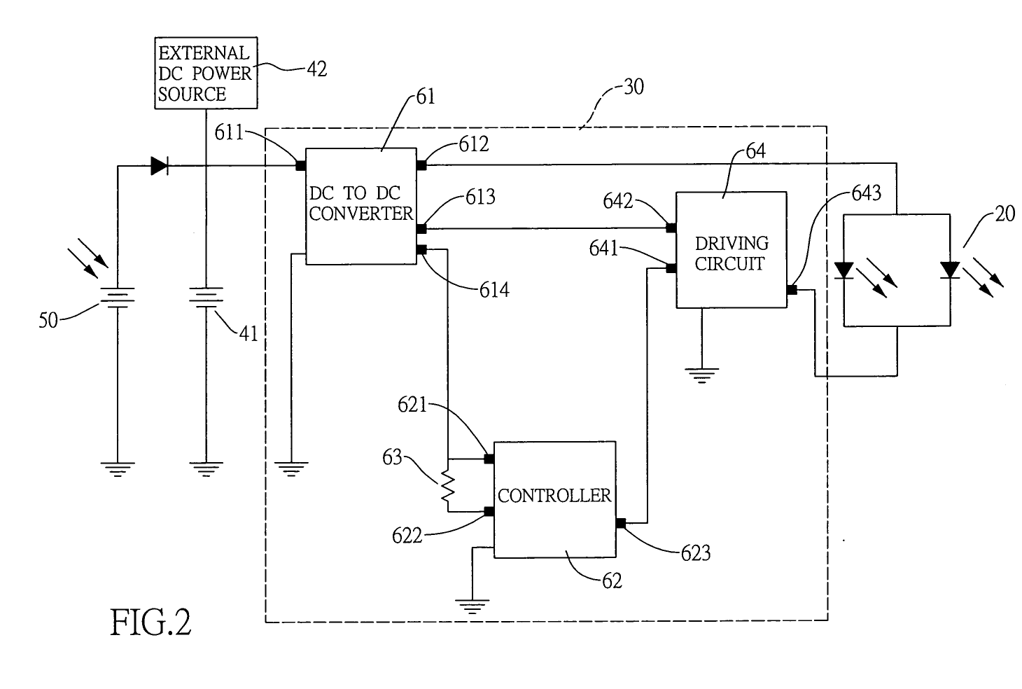

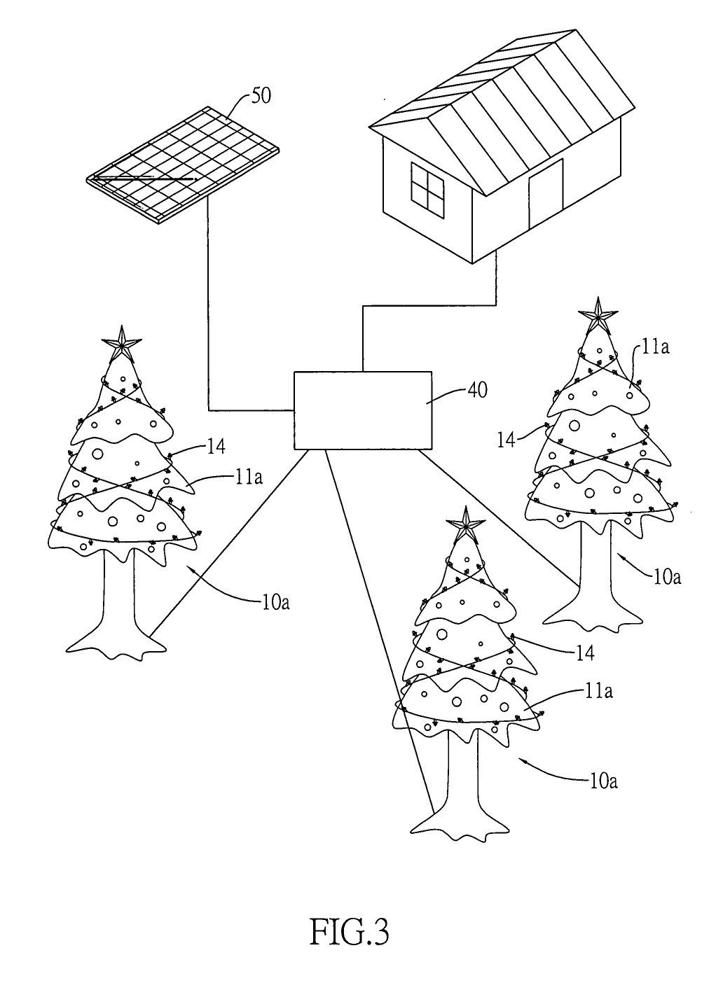

The at least one lamp (10, 10a) is mounted on the ground in a yard. Each one of the at least one lamp (10) has a casing (11), a through hole (12), a cover (13) and a light assembly. The casing (11) has a top end. The through hole (12) is defined in the casing (11) adjacent to the top end. The cover (13) is mounted on the through hole (12). In a second embodiment, each one of the at least one lamp is tree-shaped and has a casing (11a) and a light assembly. The light assembly is mounted in the casing (11), radiates through the cover (13) to light and may be light emitting diodes (LEDs) (20), as shown in FIG. 2. In the second embodiment, the light assembly is mounted around the casing (11a) and may be light bulbs (14), as shown in FIG. 3.

The rechargeable device (40) has a control circuit (30) and a rechargeable battery (41). The rechargeable battery (41) is connected electrically to the control circuit (30) and LEDs (20) to provide a working power. Furthermore, the rechargeable device (40) is connected electrically to an external direct current (DC) power source (42) to supply power to the rechargeable battery (41) when the rechargeable battery (41) has insufficient DC power.

The solar array (50) is mounted on a place such as a roof without shadow, is connected electrically to the control circuit (30), converts sunlight to direct current (DC) electricity and is connected to and recharges the rechargeable battery (41).

With further reference to FIG. 2, the control circuit (30) senses the environment and is connected to the rechargeable battery (41), directs an appropriate power source to turn on the light assembly during non-daylight hours and comprises a DC to DC converter (61), a controller (62) and a driving circuit (64).

The DC to DC converter (61) is connected to the rechargeable battery (41) to convert the DC power of the rechargeable battery (41) to multiple different voltage DC power sources and has an input terminal (611) and multiple output terminals (612, 613, 614). The input terminal (611) is connected electrically to the rechargeable battery (41) to receive the DC power from the rechargeable battery (41). One of the output terminals (612) of the DC to DC converter (61) is connected to the LEDs (20), so the LEDs obtains a working power.

The controller (62) is connected electrically to the DC to DC converter (61) and comprises a photo resistor (63), multiple input terminals (621, 622) and an output terminal (623). The photo resistor (63) is connected electrically to the DC to DC converter (61) and the controller (62) to sense a sunlight intensity. The input terminals (621, 622) are connected to one of the output terminals (614) of the DC to DC converter (61) through the photo resistor (63). Therefore, the controller (62) determines whether the sunlight intensity is weak or not according to voltage potential changes of the photo resistor (63).

The driving circuit (64) has a message input terminal (641), a power input terminal (642) and a power output terminal (643). The message input terminal (641) is connected to the controller (62) to be controlled by the controller (62). The power output terminal (643) is connected to the LEDs (20). The power input terminal (642) is connected electrically to the other output terminal (613) of the DC to DC converter (61) to obtain a working power. When the controller (62) determines that the sunlight intensity is weak, the output terminal (623) of the controller (62) outputs a triggering signal to the driving circuit (64) to light on the LEDs (20). Alternatively, the LEDs (20) is not driven by the driving circuit (64) when the sunlight is strong.

When the sunlight during the day is strong, the solar array (50) absorbs solar energy and transfers solar energy to electric energy to store electricity in the rechargeable battery (41). When the photo resistor (63) detects that there is not enough light or in the dark, LEDs (20) are lighted on by the rechargeable battery (41). In addition, when the rechargeable battery (41) does not have enough electricity, the external DC power source (42) supplies power to the LEDs (20). The solar light device is powered by the solar energy without other external electric power sources deriving from petroleum or natural gas so that using the solar light device is economical and non-hazardous to environment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A solar garden light device comprising
at least one lamp adapted to be mounted on a ground and each one of the at least one lamp having
a casing having a top end; and
a light assembly mounted on the casing;
a rechargeable device having
a control circuit; and
a rechargeable battery connected electrically to the control circuit and the light assembly of each of the at least one lamp; and
a solar array connected electrically to the control circuit, converting sunlight to direct current (DC) electricity and connected to and recharging the rechargeable battery.

2. The solar garden light device as claimed in claim 1, wherein the control circuit is connected to the rechargeable battery to the light and has
a DC to DC converter connected electrically to the rechargeable battery to convert the DC power of the rechargeable battery to multiple different voltage DC power sources and having
an input terminal electrically connected to the rechargeable battery to receive the DC power from the rechargeable battery; and
multiple output terminals;
a controller connected electrically to the DC to DC converter and having
a photo resistor connected electrically to the DC to DC converter and the controller to sense a sunlight intensity;
multiple input terminals connected to one of the output terminals of the DC to DC converter through the photo resistor, wherein the controller has a capability of determining whether the sunlight intensity is weak or not according to voltage potential changes of the photo resistor; and
an output terminal; and
a driving circuit having
a message input terminal connected to the controller to be controlled by the controller;
a power input terminal connected electrically to one of the output terminals of the DC to DC converter to obtain a working power; and
a power output terminal connected electrically to the light assembly.

3. The solar garden light device as claimed in claim 2, wherein the rechargeable device is connected electrically to an external DC power source to supply power to the rechargeable battery when the rechargeable battery has insufficient DC power.

4. The solar garden light device as claimed in claim 3, wherein
each one of the at least one lamp has
a through hole defined in the casing adjacent to the top end; and
a cover mounted on the through hole; and
the light assembly of each one of the at least one lamp is mounted in the casing and radiating through the cover of the lamp to light.

5. The solar garden light device as claimed in claim 4, wherein the light assembly of each one of the at least one lamp is light emitting diodes.

6. The solar garden light device as claimed in claim 3, wherein each one of the at least one lamp is tree-shaped; and
the light assembly of each one of the at least one lamp is mounted around the casing of the lamp.

7. The solar garden light device as claimed in claim 6, wherein the light assembly of each one of the at least one lamp is light bulbs.
